(19) United States
(12) Patent Application Publication
(10) Pub. No.: US 2026/0348846 A1
(43) Pub. Date: Nov. 5, 2026

(54) REFRACTIVE INDEX MEASUREMENT METHOD BASED ON DIGITAL IMAGE CORRELATION AND AN INVERSION METHOD

(71) Applicant: SHANGHAI JIAO TONG UNIVERSITY, Shanghai (CN)

(72) Inventors: CHEN SUN, Shanghai (CN); XINYUN TAN, Shanghai (CN); JUBING CHEN, Shanghai (CN)

(73) Assignee: SHANGHAI JIAO TONG UNIVERSITY, Shanghai (CN)

(21) Appl. No.: 19/653,194

(22) Filed: Apr. 21, 2026

(30) Foreign Application Priority Data
Apr. 22, 2025 (CN) 2025105098269

(51) Int. Cl. G01N 21/41; G01N 21/17; G06T 7/11; G06T 7/13; G06T 7/55; G06T 7/60; G06T 7/80; G06T 7/90

(52) U.S. Cl. CPC G01N 21/41; G06T 7/11; G06T 7/13; G06T 7/55; G06T 7/60; G06T 7/80; G06T 7/90; G01N 2021/1765

(57) ABSTRACT

The invention relates to a refractive index measurement method based on digital image correlation method and an inversion method. After a top-view speckle image and a side-view contour image of a droplet disposed on a speckle pattern are synchronously acquired, a consistent spatial-scale transformation between the two images is established based on geometrical optics. A Segmentation-Aided Digital Image Correlation (SA-DIC) algorithm is then used to extract the top-view speckle displacement induced by refraction, and an edge-detection algorithm is used to extract curvature parameters of the side-profile contour of the droplet. A comprehensive physical model is subsequently established to determine the droplet refractive index corresponding to any given refraction point. Finally, a particle swarm optimization (PSO) algorithm is used to iteratively optimize the incident angle and refraction parameters associated with feature points on the droplet contour, thereby obtaining an optimal refraction solution.

### CROSS-REFERENCE TO RELATED APPLICATIONS

This application claims priority to Chinese Patent Application Ser. No. CN2025105098269 filed on 22 Apr. 2025.

### TECHNICAL FIELD

The present invention relates to the technical field of optical measurement, and in particular to a refractive index measurement method based on digital image correlation and an inversion method.

### BACKGROUND ART

Existing techniques for measuring the refractive index of transparent microdroplets rely on highly precise optical instruments and are based on assumptions of idealized steady-state environmental conditions. Such techniques are not well suited to addressing interference in measurement results caused by dynamic variations in variables such as temperature and concentration, and are also difficult to use for achieving real-time and effective monitoring of dynamic changes in droplet refractive index.

### SUMMARY OF THE INVENTION

In view of the problems in existing techniques for accurately characterizing the refractive index of transparent droplets, including dependence on precision optical devices and insufficient capability for monitoring dynamic processes, the present invention provides a refractive index measurement method based on digital image correlation and an inversion method. The imaging optical path is described using a refraction model, thereby avoiding measurement errors or even measurement failure caused by inconsistencies between actual conditions and the assumptions adopted in existing methods, and significantly improving both measurement accuracy and practical applicability. A physical model established on the basis of geometrical optics is used for calculation, and only the refractive index of air at the measurement temperature is used as the computational reference. No additional standard liquid of known refractive index is required as a computational reference, thereby avoiding dependence on a reference refractive index and enhancing resistance to interference from dynamic variables under practical engineering conditions.

This invention requires no complex optical components—only standard imaging equipment—to achieve real-time, online monitoring of tiny liquid droplets. It directly tracks dynamic changes in the refractive index and concentration of solutions during processes such as evaporation, mixing, and chemical reactions. Being non-invasive, it avoids disturbing the sample, making it ideal for long-term studies of microliter-scale liquids. This provides a convenient, low-cost approach for in-situ analysis of the physical and chemical properties of solutions. In summary, this method holds great promise for a wide range of applications, including the measurement of the refractive index of transparent droplets.

The present invention is implemented through the following technical solution:

The present invention provides a refractive index measurement method based on digital image correlation and an inversion method, comprising: synchronously acquiring a top-view speckle image and a side-view contour image of a droplet disposed on a speckle pattern, establishing consistency conversion of spatial scales between the top-view speckle image and the side-view contour image based on principles of geometrical optics; after top-view speckle displacement caused by refraction is extracted by adopting a SA-DIC and curvature parameters of the side-view contour of the droplet is extracted by adopting an edge detection algorithm, a comprehensive physical model is established to obtain a droplet refractive index corresponding to any refraction point; the incident angle and refraction parameters of feature points on a droplet contour are further iteratively optimized by a PSO algorithm, thereby obtaining an optimal refraction solution.

The droplet to be measured is a transparent, homogeneous droplet and may have a moderate degree of coloration. However, during measurement under dynamically varying environmental conditions, it shall be ensured that no turbidity is caused within the droplet by crystal precipitation or undissolved substances, so as to avoid reducing the clarity and recognizability of the transmitted speckle pattern, thereby ensuring the accuracy of displacement calculation.

The contact angle of the droplet to be measured should be greater than 5° and less than 90°. If the contact angle is excessively large, the speckle pattern captured in the top-view image will undergo secondary refraction, causing obvious deformation of the speckle pattern in the image and thus increasing calculation error. If the contact angle is excessively small, the side-view contour of the droplet will no longer exhibit a regular circular-arc shape owing to the combined effect of droplet surface tension and three-phase interfacial forces, making it difficult to accurately fit the droplet contour in the side-view image using a smooth curve, which likewise significantly increases refractive-index calculation error. Therefore, appropriate control of the contact angle range not only reduces the effects of refraction and deformation during image acquisition, but also helps significantly improve the accuracy of refractive-index and displacement measurements.

The speckle pattern is preferably prepared by inkjet printing on offset paper followed by polyvinyl chloride (PVC) lamination, so that, under a magnification condition that ensures clear droplet edges, good speckle clarity and recognizability can be provided, thereby improving the accuracy of subsequent displacement calculation.

The top-view speckle image and the side-view contour image are acquired by means of a dual-view coupled imaging system comprising a top-view camera and a side-view camera. The optical path of the top-view camera operates in a transmissive imaging mode, in which transmitted light from the speckle pattern on the feature-bearing surface enters from a planar backlight source through the bottom of the droplet, passes through the interior of the droplet, is refracted at the liquid-air interface, and is finally recorded by the top-view camera as a speckle-image difference between droplet-present and droplet-absent states. The side-view camera captures a backlit side-view contour image formed after light from a vertical planar light source passes through the surface of the liquid under test and undergoes two refractions, thereby clearly recording subtle variations in the side geometric morphology of the droplet under different states and enabling accurate capture and analysis of the dynamic behavior characteristics and physical parameters of the droplet. In order to ensure the completeness and accuracy of droplet-edge identification, the field of view of the top-view camera is arranged vertically, that is, perpendicular to the horizontal speckle plane carrying the droplet, and covers the complete circular contour of the droplet; the field of view of the side-view camera is horizontally aligned with the center of the speckle plane and covers the entire semicircular contour of the droplet.

The top-view image acquisition uses bottom transmitted illumination so as to ensure the clarity and recognizability of the speckle pattern. The side-view image acquisition uses planar backlight illumination so as to avoid surface-reflection artifacts caused by projected illumination, thereby enhancing the contour contrast of the side-view image and improving contour-recognition accuracy.

The top-view camera and the side-view camera perform image acquisition at the same sampling frequency. Specifically, the two cameras use a unified sampling frequency and a precise trigger signal to synchronously record variations in droplet morphology and speckle pattern during a dynamic process, thereby ensuring a strict correspondence between the recorded images on the time axis and enabling accurate parameter calibration and high-fidelity reconstruction of the dynamic morphology of the droplet.

The principles of geometrical optics specifically comprise:
1) Calibrating the top-view camera to obtain intrinsic camera parameters, including focal length, optical-center position, and lens-distortion coefficients.
2) Determining, according to the correspondence between the pixel coordinates of calibration-board feature points extracted from the top-view image and actual spatial points, the actual physical dimensions of the droplet contour in the top-view state, and establishing a two-dimensional spatial-scale mapping relationship for the top-view image.
3) Analyzing and fitting the side-view image acquired at the same instant so as to extract geometric features of the side-view contour of the droplet, matching the droplet diameter measured from the side-view image with the droplet diameter at the corresponding instant in the top-view image, and establishing a spatial correspondence between the two cameras, thereby realizing a consistent spatial-scale transformation between the two cameras, enabling image information acquired from different viewpoints to be accurately unified into the same spatial coordinate system, and effectively improving the accuracy and stability of droplet geometric-parameter measurement.

The calibration described herein adopts but is not limited to the Zhang Zhengyou calibration method.

The SA-DIC algorithm specifically comprises:
A) Segmenting the top-view speckle image after the spatial-scale transformation, dividing the image into a plurality of subregions having different characteristics, and performing more accurate feature matching within each subregion according to its characteristics, so as to address the displacement discontinuity problem that readily occurs at the droplet boundary during measurement;
B) Comparing the speckle images corresponding to different states of the surface under test with a reference image, and using grayscale matching to determine point-to-point correspondence in each segmented subregion, thereby obtaining surface-displacement information; specifically, in displacement-field measurement, a DIC algorithm based on multi-subregion segmentation is employed, and after image segmentation, corresponding positions in the reference image and the target image are determined for each subregion by point-by-point matching.

The point-by-point matching uses a zero-normalized sum of squared differences (ZNSSD) to characterize the degree of matching between corresponding subregions in different images, specifically:

$$C ( p ) = {\sum }_{x = - M}^{M} {\sum }_{y = - M}^{M} [ \frac{f ( x , y ) - {f}_{m}}{\sqrt{{\sum }_{x = - M}^{M} {\sum }_{y = - M}^{M} {[ f ( x , y ) - {f}_{m} ]}^{2}}} - \frac{g ( {x}^{′} , {y}^{′} ) - {g}_{m}}{\sqrt{{\sum }_{x = - M}^{M} {\sum }_{y = - M}^{M} {[ g ( {x}^{′} , {y}^{′} ) - {g}_{m} ]}^{2}}} ] ,$$

where the mean grayscale value of the reference subregion is

$${f}_{m} = \frac{1}{{( 2 M \times 1 )}^{2}} {\sum }_{x = - M}^{M} {\sum }_{y = - M}^{M} f ( x , y ) ,$$

and the mean grayscale value of the target subregion is

$${g}_{m} = \frac{1}{{( 2 M \times 1 )}^{2}} {\sum }_{x = - M}^{M} {\sum }_{y = - M}^{M} g ( {x}^{′} , {y}^{′} ) .$$

Here, f(x, y) represents the grayscale value of the point P(x, y) in the reference subregion when matching a single subregion, g(x′, y′) represents the grayscale value of P′(x′, y′), and p denotes the deformation-parameter vector from the reference subregion to the target subregion.

The smaller the criterion value C(p), the more reliable the matching between the reference subregion and the target subregion. On this basis, the displacement of the target region is inferred by solving for the deformation-parameter vector p that minimizes C(p), thereby establishing a geometric mapping relationship. For adjacent subregions, joint optimization is further performed in combination with displacement-continuity constraints, thereby effectively reducing local matching errors.

The edge-detection algorithm uses an improved Canny edge-detection algorithm to construct an image edge-detection model, so as to accurately extract edge information from the side-view image of the droplet to be measured. The algorithm may employ, but is not limited to, the technique disclosed in An Improved Canny Edge Detection Algorithm published by Rong W. et al. in 2014.

The physical model described above is established according to the actual refractive optical-path structure and is used to determine a quantitative relationship among the refractive index of the liquid under test, the droplet contour, and the displacement of the speckle-pattern base image. In order to accurately quantify the refractive index of a transparent droplet, precise speckle displacement, the side-view droplet contour, and the refractive indices of the respective media through which the imaging light passes in both viewing directions are all incorporated into the refractive model, and more accurate model-parameter values are obtained by calibration, thereby significantly improving measurement accuracy.

The comprehensive physical model specifically uses the feature-bearing surface on which the droplet is located as a reference plane, and selects any maximum contour cross-section of the droplet for analysis. Assuming that the plane containing the maximum contour cross-section is an X-O-Z coordinate plane, and that the origin thereof is the projected coordinate position of the center of the target plane of the top-view industrial camera lens on the droplet base plane, the coordinates of any refraction point R(x_{f}, z_{f}) satisfy:

$$\{ \begin{matrix}{z}_{f} = {z}_{0} - \frac{{z}_{0}}{{x}_{1}^{′}} {x}_{f} \\ f ( {x}_{f} , {z}_{f} ) = 0\end{matrix} ,$$

where: Z₀(0, z₀) is the optical center of the lens in a pinhole imaging model, and R(x_{f}, z_{f}) denotes the coordinate position of any refraction point on the maximum contour cross-section. When no droplet is present on the substrate, the point corresponding to R on the X-axis is the object point X₁(x₁, 0); when a droplet is present, the corresponding spatial point is the image point

$${X}_{1}^{′} ( {X}_{1}^{′} , 0 ) .$$

The height z₀ of the lens optical center in pinhole imaging is obtained by Zhang Zhengyou's camera calibration method. The mathematical expression of the maximum contour f(x, z) is obtained by the improved Canny edge detection algorithm. The correspondence between the two points X₁ and

$${X}_{1}^{′}$$

can be determined by the DIC matching relationship. The refractive index n of the droplet corresponding to any refraction point is then obtained from n sin γ=n_{α} sin α, where the refraction incident angle is

$$α = {cos}^{- 1} ( \frac{\vec{n} \vec{{n}_{2}}}{\vert \vec{n} \vert \vert \vec{{n}_{2}} \vert} ) ,$$

the refraction angle is

$$γ = {cos}^{- 1} ( \frac{\vec{n} \vec{{n}_{1}}}{\vert \vec{n} \vert \vert \vec{{n}_{1}} \vert} ) .$$

θ is the angle between the object point X₁, the image point

$${X}_{1}^{′} ,$$

and the refraction point R(x_{f}, z_{f}), n_{α} is the refractive index of air at a fixed temperature, vector \vec{n₁}=(x_{f}−x₁, z_{f}), vector \vec{n₂}=(−x_{f}, z₀−z_{f}), and vector

$$\vec{n} = ( \frac{\partial f}{\partial x} , \frac{\partial f}{\partial z} ) .$$

During the specific calculation process, a feature-point matching algorithm is used to extract a large number of feature points from images acquired before and after droplet-induced refraction; however, only feature points located on the maximum side-view contour are selected for subsequent refractive-index calculation. Since the displacement of each feature point conforms to the refraction model, a refractive-index value can in principle be calculated independently for each feature point. However, refractive-index calculation based on a single feature point is easily affected by the combined influence of SA-DIC measurement error, edge-detection error, and error in the location of the refraction point, and therefore may deviate significantly from the true value. If direct global averaging is adopted, differences in data quality among feature points will be ignored, thereby causing error averaging and reducing the final measurement accuracy.

The PSO algorithm is used to iteratively optimize the incident angle and refraction parameters of feature points on the droplet contour. Specifically, s feature points are selected for optimization-based refractive-index calculation. At the beginning of the calculation, particle positions and velocities are initialized, and upper and lower bounds of the search space are defined. In each iteration, the refractive-index values corresponding to the s feature points are treated as the particle positions to be optimized and updated, and the refractive index is then evaluated according to a fitness function, specifically: vᵢ(t+1)=w(t)·vᵢ(t)+c₁·r₁·(pBestᵢ−xᵢ)+c₂·r₂·(gBestᵢ−xᵢ), xᵢ(t+1)=xᵢ(t)+vᵢ(t+1), where w(t) is an inertia weight controlling the influence of the current particle velocity on updating; c₁ and c₂ are learning factors for the individual and the swarm respectively; r₁ and r₂ are random factors determining the randomness of the search; pBestᵢ is the historical best position of the particle, namely the refractive-index value calculated from a single refraction point; gBestᵢ is the global best position, namely the refractive-index value obtained according to the weighting scheme; xᵢ is the current particle position. During the optimization process, the objective of each particle is to minimize the fitness function F(x), which takes into account differences between the incident-angle term and the outgoing-angle term associated with refractive index and assigns weights according to the condition at each point.

The fitness function is:

$$F ( x ) = {\sum }_{i = 1}^{s} 100 w ( i ) * {( x * {sin}_{in} ( i ) - {sin}_{out} ( i ) )}^{2} ,$$

where the weighting coefficients is

$$w ( i ) = \frac{{max}_{w} - 1}{max ( {sin}_{in} ( i ) ) - min ( {sin}_{in} ( i ) )} {sin}_{in} ( i ) + \frac{{max}_{w} - 1}{max ( {sin}_{out} ( i ) ) - min ( {sin}_{out} ( i ) )} {sin}_{out} ( i ) + 2 ,$$

and max_{w} denotes a parameter for controlling the weighting assigned to the incident-angle and outgoing-angle terms, sinᵢₙ(i) and sinₒᵤₜ(i) are the incident sine and the exit sine of the i-th feature point respectively, and x denotes the refractive index to be optimized.

The evaluated refractive index is obtained by continuously updating particle velocities and positions through the PSO algorithm. When the iterative change in the global fitness value F(x) is smaller than a preset threshold, the optimization result is deemed to have converged, and iteration is terminated when the optimization termination condition is satisfied. The global optimum position gBest, namely the optimal refractive-index solution n, is then determined by inversion in the iterative process, specifically: n=argmin[F(xᵢ, sinᵢₙ, sinₒᵤₜ, α, γ, w(i), . . . )], F(x)−F(x)ₚᵣₑᵥ<ε, where: F(x)ₚᵣₑᵥ is the fitness function result of the previous optimization; F is the set threshold.

The threshold adopted in the present invention is ε=10⁻⁶.

Preferably, during the setting of the fitness weighting coefficient, a smaller weighting coefficient is assigned to a region closer to the center of the droplet because the gradient of variation in the refraction angle is larger there; conversely, a larger weighting coefficient is assigned to a far-field region because the stability of the refraction angle is enhanced there.

### Technical Effects

The present invention employs a comprehensive refraction-physics model based on geometrical optics and the law of refraction, in combination with the top-view speckle image and the side-view contour image of a droplet, and further uses SA-DIC and an improved Canny edge-detection algorithm to accurately quantify speckle displacement induced by refraction and curvature characteristics of the droplet contour. The incident angle and refraction parameters in the physical model are further solved by iterative optimization using the PSO algorithm. Compared with existing methods that rely on precision optical components, static measurement conditions, and standard liquids of known refractive index, the present invention can effectively improve the accuracy, stability, and environmental adaptability of refractive-index measurement for transparent droplets. The relative measurement error is no greater than 2.196%, reaching the accuracy level of a laboratory-grade refractometer, and real-time, non-invasive monitoring of dynamic changes in the refractive index of small-volume liquids is achieved.

### BRIEF DESCRIPTION OF THE DRAWINGS

FIG. 1 is a flow chart of the present invention;

FIG. 2 is a schematic diagram of an application scenario of the embodiment;

FIG. 3 is a schematic diagram of the system of the embodiment.

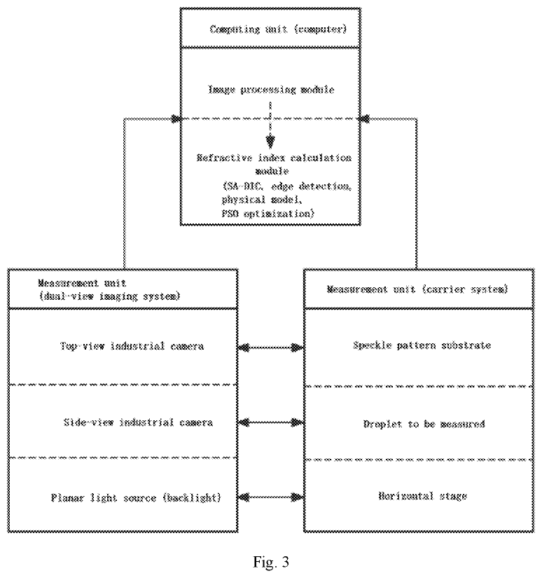

### DETAILED DESCRIPTION

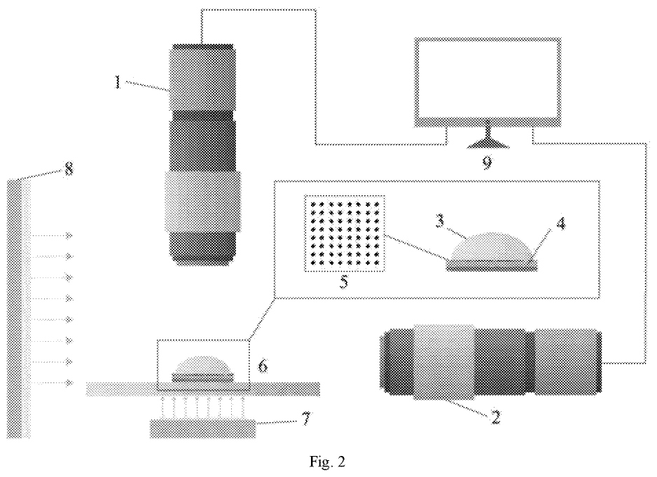

As shown in FIG. 2, the present embodiment relates to a refractive index measurement apparatus based on digital image correlation and an inversion method. The apparatus comprises a computing unit (not shown), two industrial cameras 1 and 2 connected thereto, a speckle substrate 5, a planar light source 7, a backlight source 8, and a stage 6. The stage 6 is adjusted to a horizontal state and is provided with the planar light source. The speckle substrate 5 is placed on the stage and remains fixed. A sessile droplet 3 to be measured is dispensed onto the surface of the speckle substrate by a pipette. The two industrial cameras are respectively positioned directly above the droplet to be measured and at a horizontal side thereof. The planar light source 7 and the backlight source 8 are respectively arranged behind the droplet to be measured along the viewing directions of the side-view camera and the top-view camera, so that the two industrial cameras can perform dual-view imaging of the droplet to be measured. The computing unit receives and processes image data acquired by the dual-view imaging system and calculates the refractive index of the droplet to be measured on the basis of a pre-established physical model.

The speckle substrate is made of a light-transmitting material and is used in combination with the planar light source 7 disposed below, so that the top-view industrial camera can clearly acquire image information of the droplet, thereby ensuring measurement accuracy.

In this embodiment, the droplet 3 to be measured is distilled water. Measurement is performed after the droplet to be measured comes into contact with the substrate and its morphology becomes stable. The quartz substrate 4, the speckle substrate 5, and the stage 6 are all light-transmitting, and are used together with the planar light source 7 arranged at the rear, so that the droplet 3 to be measured can still be clearly imaged even under low-ambient-light conditions, thereby ensuring measurement accuracy.

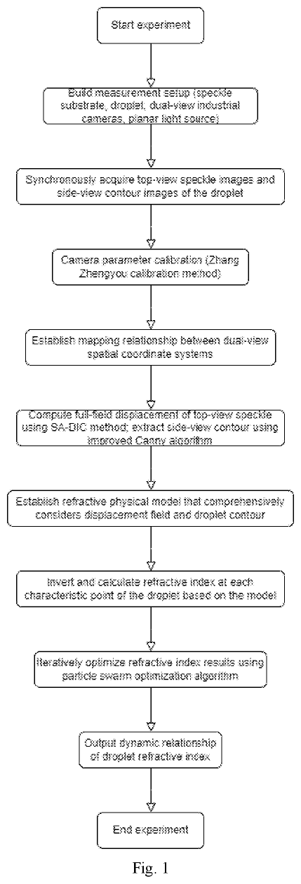

As shown in FIG. 1, the method for measuring dynamic changes in the refractive index of a transparent droplet by using the above apparatus in this embodiment specifically comprises:
S1. Setting up the measurement apparatus.
S2. Cleaning the stage, fixing the quartz substrate 4 and the speckle substrate 5, and placing the droplet 3 to be measured on the speckle substrate 5 in a sessile manner.
S3. According to measurement requirements, starting industrial cameras 1 and 2 to respectively capture, from two viewing directions, the dynamic morphological evolution of the droplet to be measured during timed evaporation.
S4. After completion of the continuous dynamic image acquisition, while maintaining the original camera parameters of industrial cameras 1 and 2, capturing the original speckle image without the droplet under test, and calibrating the top-view lens by using a calibration plate so as to obtain intrinsic parameters of industrial camera 1. In this embodiment, the calibration method employed is Zhang's calibration method. By acquiring data under multiple poses of the calibration plate through in-plane translation, elevation, and rotation, a mapping relationship between the extrinsic-parameter translation matrix and the height of the lens optical center is established so as to determine the parameter z₀.
S5. Comparing and analyzing the speckle image covered by the droplet to be measured, continuously captured by industrial camera 1, with the original speckle image 5, taking the fully evaporated image as the DIC reference image and the images acquired at each moment as target images, and calculating speckle displacement by using the SA-DIC method. By calculating image displacement before and after refraction at feature-bearing surface points, a displacement field in the region near the maximum contour in the top view is obtained.
S6. Taking the side-view images synchronously acquired by industrial camera 2 at each moment as target images for contour recognition, obtaining a continuous and smooth circular-arc contour by edge detection, and establishing a complete geometric model including an arc segment corresponding to the droplet side contour and a straight-line segment corresponding to the substrate plane, together with a mathematical expression thereof.
S7. Using the computer 9 to calculate the refractive index of the droplet to be measured, specifically comprising:
   1) An appropriate number of refraction points are uniformly selected on the identified edge contour according to the calculation accuracy and efficiency requirements.
   2) Based on the numerical calculation framework constructed by the established physical model, the single-point refractive index value corresponding to the refraction point selected in step 1) is calculated point by point.
   3) Combining the PSO algorithm to perform parameter inversion and obtain the optimized refractive index.
   4) Based on the refractive index data of the droplet to be measured calculated at each moment, the time-refractive index change relationship of the droplet to be measured during the dynamic change process is obtained.

Experimental results demonstrate the feasibility of the established physical model using a camera with a resolution of 3648×5472 pixels. A 0.25 mm×0.25 mm checkerboard calibration plate (5 mm×5 mm overall) was selected for camera calibration. To verify the feasibility of the established physical model, 10 μL of sodium chloride solution with mass fractions of 0%, 5%, 10%, 15%, and 20% was used as the experimental fluid. Under a constant-temperature condition of 20±0.5 °C, the evaporation process was recorded at a synchronized acquisition interval of 10 s per frame until the working fluid was completely evaporated or crystallization occurred. The completely evaporated image served as the DIC reference image, and the images captured at each moment served as the target images. A sampling interval of 20 pixels was set, and the image displacement of characteristic-surface points before and after refraction was calculated to obtain a displacement field in the vicinity of the maximum contour. The side-view images acquired at respective moments were used as contour-recognition images. The contour obtained by Canny edge detection and the displacement field were combined with the physical model and the refractive-index-concentration relationship to analyze dynamic changes in the refractive index and concentration of the target liquid.

As shown in Table 1, the maximum relative error between the refractive index measured by this method and the standard values of various classical methods is 2.196%, demonstrating that the present method has relatively high practical accuracy within a concentration range of 0-20%, and achieves low-cost, high-precision, dynamic refractive-index measurement.

TABLE 1

| Concentration | The | | | Geometrical | | | |
|---|---|---|---|---|---|---|---|
| of the | present | Abbe | | optics | | Michelson | |
| test solution | invention | refractometer | Error | method | Error | interferometer | Error |
| 0% | 1.3348 | 1.3330 | 0.1350% | 1.3330 | 0.1350% | 1.3377 | 0.2170% |
| 5% | 1.3517 | 1.3424 | 0.6930% | 1.3432 | 0.6340% | 1.3403 | 0.8510% |
| 10% | 1.3645 | 1.3510 | 0.9990% | 1.3534 | 0.8230% | 1.3516 | 0.9540% |
| 15% | 1.3873 | 1.3609 | 1.9400% | 1.3635 | 1.7430% | 1.3631 | 1.7750% |
| 20% | 1.4009 | 1.3708 | 2.1960% | 1.3737 | 1.9790% | 1.3747 | 1.9060% |

Compared with the existing techniques, the present invention does not require complex optical devices, and real-time online monitoring of micro-volume droplets can be achieved by using only conventional imaging equipment. The non-invasive characteristic of the present invention avoids interference with the sample, and the present invention is applicable to long-term dynamic studies of micro-volume liquids at the microliter scale, thereby providing a convenient and low-cost measurement solution for in-situ analysis of physicochemical properties of solutions.

In summary, the present method overcomes the defects of conventional techniques in which measurement accuracy is affected by dynamic environmental interference and optical-component dependence. The present method can achieve real-time online monitoring of micro-volume droplets by using only conventional imaging equipment. While maintaining the advantages of non-contact measurement, the relative error between the measurement result and the standard value obtained by classical measurement methods is 2.196%, which is close to the accuracy level of a laboratory-grade refractometer and satisfies practical engineering measurement requirements. The present method can directly track dynamic changes in the refractive index and concentration of a solution during evaporation, mixing, and chemical reaction processes. Its non-invasive characteristic avoids interference with the sample, and the method is applicable to long-term dynamic studies of micro-volume liquids at the microliter scale, thereby providing a convenient and low-cost measurement solution for in-situ analysis of physicochemical properties of solutions.

The present invention also provides a computer device, comprising a memory and a processor, wherein the memory stores a computer program, and the processor executes the computer program to implement the above methods.

The present invention further provides a non-transitory computer readable storage medium, wherein the medium stores a computer program, and the program is executed by processor to implement the above methods.

The above specific embodiments may be partially modified in different manners by those skilled in the art without departing from the principle and purpose of the present invention. The protection scope of the present invention shall be determined by the claims, and shall not be limited to the above specific embodiments. Any embodiment falling within the protection scope of the present invention shall be encompassed by the present invention.

What is claimed is:

1. A refractive index measurement method based on digital image correlation method and an inversion method, comprising a non-transitory computer readable medium operable on a computer with memory for the refractive index measurement method based on digital image correlation method and the inversion method, and comprising program instructions for executing the following steps of:
synchronously acquiring a top-view speckle image and a side-view contour image of a droplet disposed on a speckle pattern, establishing consistency conversion of spatial scales between the top-view speckle image and the side-view contour image based on principles of geometrical optics; after top-view speckle displacement caused by refraction is extracted by adopting SA-DIC and curvature parameters of the side-view contour of the droplet is extracted by adopting an edge detection algorithm, a comprehensive physical model is established to obtain a droplet refractive index corresponding to any refraction point; the incident angle and refraction parameters of feature points on a droplet contour are further iteratively optimized by the PSO algorithm, thereby obtaining an optimal refraction solution, and
the comprehensive physical model uses a feature-bearing surface on which the droplet is located as a reference plane, and selects any maximum-contour cross section of the droplet for analysis, and assuming that a plane where the maximum-contour cross section is located is an x-O-z coordinate plane, and that an origin of the X-O-Z coordinate plane is a projected coordinate position of a center of a target plane of a top-view industrial camera lens onto a droplet base plane, coordinates of any refraction point R(x_{f}, z_{f}) satisfy:
$$\{ \begin{matrix}{z}_{f} = {z}_{0} - \frac{{z}_{0}}{{x}_{1}^{′}} {x}_{f} \\ f ( {x}_{f} , {z}_{f} ) = 0\end{matrix} ,$$
where Z₀(0, z₀) is an optical center of the lens in a pinhole imaging model, and R(x_{f}, z_{f}) is a coordinate position of any refraction point on the maximum contour cross section; when there is no droplet on the substrate at a certain point on the imaging target surface, the actual spatial point corresponding to point R on the X-axis is object point X₁(x₁, 0); when there is a droplet, the corresponding spatial point is image point
$${X}_{1}^{′} ( {x}_{1}^{′} , 0 ) ;$$
a height z₀ of the lens optical center in the pinhole imaging model is obtained by Zhang Zhengyou's calibration method; a mathematical expression of the maximum profile f(x, z) is obtained by the improved Canny edge detection algorithm, and the correspondence between the two points X₁ and
$${X}_{1}^{′}$$
can be determined by the DIC matching relationship, and the refractive index of the droplet corresponding to any refraction point is obtained according to n sin γ=n_{α} sin α, where: the refraction incident angle is
$$α = {cos}^{- 1} ( \frac{\vec{n} \vec{{n}_{2}}}{\vert \vec{n} \vert \vert \vec{{n}_{2}} \vert} ) ,$$
and the refraction angle is
$$γ = {cos}^{- 1} ( \frac{\vec{n} \vec{{n}_{1}}}{\vert \vec{n} \vert \vert \vec{{n}_{1}} \vert} ) ,$$
θ is an included angle formed by the object point X₁, the image point
$${X}_{1}^{′} ,$$
and the refraction point R(x_{f}, z_{f}) is, n_{α} is the refractive index of air at a fixed temperature, and the vector \vec{n₁}=(x_{f}−x₁, z_{f}), and vector \vec{n₂}=(−x_{f}, z₀−z_{f}), and vector
$$\vec{n} = ( \frac{\partial f}{\partial x} , \frac{\partial f}{\partial z} ) .$$

2. The refractive index measurement method based on digital image correlation method and an inversion method according to claim 1, characterized in that the top-view speckle image and the side-view contour image are acquired by a dual-view coupled imaging system comprising a top-view camera and a side-view camera, wherein: an optical path of the top-view camera adopts a transmissive imaging mode, in which transmitted light carrying the speckle pattern on the feature-bearing surface is incident from a planar backlight source through a bottom of the droplet, passes through an interior of the droplet, is refracted at a liquid-air interface, and is finally recorded by the top-view camera as a speckle-image difference between a droplet-present state and a droplet-absent state; and the side-view camera acquires a backlit side-view contour image formed by light emitted from a vertical planar light source and refracted twice by the surface of the liquid to be measured, so as to record subtle changes in side geometric morphology of the droplet under different states, thereby accurately capturing and analyzing dynamic behavior characteristics and physical parameters of the droplet.

3. The refractive index measurement method based on digital image correlation method and an inversion method according to claim 1, characterized in that the principles of geometrical optics comprise:
i) calibrating the top-view camera to obtain intrinsic parameters of the camera, including a focal length, an optical-center position, and lens-distortion coefficients;
ii) based on the correspondence between the pixel coordinates of the calibration plate feature points extracted from the top-view image and the actual spatial points, the actual physical size of the droplet contour in the top-view state is accurately determined, and a two-dimensional spatial scale mapping relationship of the top-view image is established;
iii) analyzing and fitting the side-view images taken at the same moment to extract the geometric features of the droplet's side profile, and the droplet diameter measured from the side-view image is matched with the droplet diameter at the corresponding moment in the top-view image, and a spatial association is established between the two cameras, and this allows for consistent conversion of spatial scales between the two cameras, allowing image information obtained from different perspectives to be accurately unified into the same spatial coordinate system.

4. The refractive index measurement method based on digital image correlation method and an inversion method according to claim 1, characterized in that the SA-DIC comprises:
a) segmenting the top-view speckle image after consistency conversion into multiple sub-regions with different characteristics, and achieving more accurate feature matching within each sub-region based on its characteristics;
b) the speckle patterns of the surface to be measured under different conditions are compared with a reference image, and grayscale matching is used to determine the correspondence between points in the subregions of the image, thereby obtaining surface displacement information, and
specifically, in displacement field measurement, a DIC algorithm based on multi-subregion segmentation is adopted; after image segmentation, corresponding positions in the reference image and the target image are determined for each individual subregion by point-by-point matching.

5. The refractive index measurement method based on digital image correlation method and an inversion method according to claim 4, characterized in that the point-by-point matching uses the zero-normalized sum of squared differences (ZNSSD) to describe the matching degree of each sub-region in different images, specifically:
$$C ( p ) = {\sum }_{x = - M}^{M} {{\sum }_{y = - M}^{M} [ \frac{f ( x , y ) - {f}_{m}}{\sqrt{{\sum }_{x = - M}^{M} {{\sum }_{y = - M}^{M} [ f ( x , y ) - {f}_{m} ]}^{2}}} - \frac{g ( {x}^{′} , {y}^{′} ) - {g}_{m}}{\sqrt{{\sum }_{x = - M}^{M} {{\sum }_{y = - M}^{M} [ g ( {x}^{′} , {y}^{′} ) - {g}_{m} ]}^{2}}} ]}^{2} ,$$
where the mean grayscale value of the reference subregion is
$${f}_{m} = \frac{1}{{( 2 M \times 1 )}^{2}} {\sum }_{x = - M}^{M} {\sum }_{y = - M}^{M} f ( x , y ) ,$$
and the mean grayscale value of the target subregion is
$${g}_{m} = \frac{1}{{( 2 M \times 1 )}^{2}} {\sum }_{x = - M}^{M} {\sum }_{y = - M}^{M} g ( {x}^{′} , {y}^{′} ) ,$$
in which f(x, y) represents the grayscale value of the point P(x,y) in the reference subregion when matching a single subregion, g(x′, y′) represents the grayscale value of P′(x′, y′), and p denotes the deformation-parameter vector from the reference subregion to the target subregion.

6. The refractive index measurement method based on digital image correlation method and an inversion method according to claim 5, characterized in that the displacement value of the target area is calculated by establishing a geometric mapping relationship by solving the deformation parameter vector p that minimizes the correlation coefficient C(p); for adjacent sub-areas, joint optimization is performed in combination with displacement continuity constraints, thereby effectively reducing local matching errors.

7. The refractive index measurement method based on digital image correlation method and an inversion method according to claim 1, characterized in that among the feature points extracted from the images before and after refraction of the droplet using a feature point matching algorithm, the feature points located on the maximum side-view contour are included in the subsequent refractive index calculation.

8. The refractive index measurement method based on digital image correlation method and an inversion method according to claim 1, characterized in that the PSO algorithm performs iterative optimization on the incident angle and refraction parameters of feature points on the droplet contour, wherein the iterative optimization comprises: selecting s feature points for optimization-based refractive-index calculation; initializing particle positions and velocities at the beginning of calculation; and defining upper and lower bounds of a search space, and
in each iteration, refractive-index values corresponding to the s feature points are taken as particle positions to be optimized and updated, and the refractive index is evaluated according to a fitness function, and an updated particle velocity and an updated particle position are expressed as: vᵢ(t+1)=w(t)·vᵢ(t)+c₁·r₁·(pBestᵢ−xᵢ)+c₂·r₂·(gBestᵢ−xᵢ), and the updated particle position xᵢ(t+1)=xᵢ(t)+vᵢ(t+1), where w(t) is an inertia weight that controls the influence of the particle's current velocity on the update; c₁ and c₂ are the learning factors for individuals and groups; r₁ and r₂ are random factors that determine the randomness of the search; pBestᵢ is the particle's historical best position, that is, the refractive index calculated for a single refraction point; gBestᵢ is the global best position, that is, the refractive index value obtained according to the weight; xᵢ is the current calculated particle position, and in the optimization process, the goal of each particle is to minimize the fitness function F(x), which takes into account the differences in the incident and exit angles related to the refractive index and assigns weights according to the situation at each point.

9. The refractive index measurement method based on digital image correlation method and an inversion method according to claim 8, characterized in that fitness function is expressed as:
$$F ( x ) = {\sum }_{i = 1}^{s} 100 w ( i ) * {( x * {sin}_{in} ( i ) - {sin}_{out} ( i ) )}^{2} ,$$
wherein: the weighting coefficient is
$$w ( i ) = \frac{{max}_{w} - 1}{max ( {sin}_{in} ( i ) ) - min ( {sin}_{in} ( i ) )} {sin}_{in} ( i ) + \frac{{max}_{w} - 1}{max ( {sin}_{out} ( i ) ) - min ( {sin}_{out} ( i ) )} {sin}_{out} ( i ) + 2 ,$$
and max_{w} represent a parameter that control the weights of the incident angle and the refraction angle, sinᵢₙ(i) and sinₒᵤₜ(i) are the incident sine and the exit sine of the i-th feature point respectively, and x is the refractive index value to be optimized, and
the evaluated refractive index is obtained by continuously iterating particle velocities and particle positions through the PSO algorithm, and when an iterative change in a global fitness value F(x) is smaller than a preset threshold, an optimization result is determined to have converged, and iteration is stopped when an optimization termination condition is satisfied, and
a global optimum position gBest, namely an optimal refractive-index solution n, is obtained in the iterative calculation as follows: n=argmin[F(xᵢ, sinᵢₙ, sinₒᵤₜ, α, γ, w(i), . . . )], F(x)−F(x)ₚᵣₑᵥ<ε, where: F(x)ₚᵣₑᵥ is the fitness function result of the previous optimization step; F is the preset threshold.

10. The refractive index measurement method based on digital image correlation method and an inversion method according to claim 9, characterized in that, during the setting of the fitness weighting coefficient, a weighting coefficient assigned to a refraction-angle term in a region closer to a center of the droplet is smaller than a weighting coefficient assigned to a refraction-angle term in a far-field region.
